(19) United States
(12) Patent Application Publication
(10) Pub. No.: US 2020/0206062 A1
(43) Pub. Date: Jul. 2, 2020

(54) WEARABLE ROBOT

(71) Applicant: LG ELECTRONICS INC., Seoul (KR)

(72) Inventors: Jinju KIM, Seoul (KR); Seongmin KIM, Seoul (KR); Kyutae PARK, Seoul (KR); Sojin PARK, Seoul (KR); Seunghyun SONG, Seoul (KR); Wookjun CHUNG, Seoul (KR)

(21) Appl. No.: 16/583,744

(22) Filed: Sep. 26, 2019

Related U.S. Application Data
(63) Continuation of application No. PCT/KR2019/000059, filed on Jan. 2, 2019.

(51) Int. Cl. A61H 3/00; B25J 9/00

(52) U.S. Cl. CPC A61H 3/00; B25J 9/0006; A61H 2201/1628; A61H 2201/1671; A61H 2201/165; A61H 2003/007; A61H 2201/0192; A61H 2201/1215; A61H 2201/1623; A61H 2201/1642

(57) ABSTRACT

A wearable robot may include a rear supporting portion or a rear support provided behind a body of a user and a hip joint driving unit or hip support including a center portion or center support fastened to the rear supporting portion and a pair of extension portions or extensions extending from the center portion to a hip joint side of the user. The wearable robot may further include a pair of upper rotational shafts provided on the rear supporting portion and spaced apart from each other by a first distance in a horizontal direction, a pair of upper binders connected to the upper rotational shafts, a pair of lower rotational shafts provided on the rear supporting portion and spaced apart from each other by a second distance shorter than the first distance in a horizontal direction, and a pair of lower binders connected to the lower rotational shafts and provided below the upper binders.

### CROSS-REFERENCE TO RELATED APPLICATION(S)

The present application is a continuation application of PCT Patent Application No. PCT/KR2019/000059, filed on Jan. 2, 2019, which is hereby incorporated by reference in its entirety.

### BACKGROUND

### 1. Field

The present disclosure relates to assistive and/or rehabilitative technology.

### 2. Background

Wearable robots or robotic exoskeletons may assist and/or augment a movement or strength of a user by providing an assistive force at various joints. For example, wearable robots may be used by those who have difficulty walking due to disability or aging, or may be used to enhance one's ability to perform at least one task.

The wearable robot may assist such an action of the user by providing the user with an assistive force generated from a driving device such as a motor. Such a wearable robot may be worn on the user's waist and/or legs. The wearable robot may have a multi-joint skeletal structure worn on various body parts of the user.

Examples of wearable robots are provided in Korean Registration Patent Number 10-1219795 and U.S. Patent Publication No. 2015/0134080. However, the conventional wearable robot may be inconvenient and uncomfortable upon wearing. The above references are incorporated by reference herein where appropriate for appropriate teachings of additional or alternative details, features and/or technical background.

### BRIEF DESCRIPTION OF THE DRAWINGS

Embodiments will be described in detail with reference to the following drawings in which like reference numerals refer to like elements, and wherein:

FIG. 1 is a view illustrating a state in which a wearable robot according to an embodiment is worn by a user;

FIG. 2 is a view illustrating a state in which the wearable robot according to an embodiment is worn by the user, when viewed in a different direction;

FIG. 3 is a perspective view of the wearable robot according to an embodiment;

FIG. 4 is a front view of the wearable robot according to an embodiment;

FIG. 5 is a rear view of the wearable robot according to an embodiment;

FIG. 6 is a right side view of the wearable robot according to an embodiment;

FIG. 7 is a left side view of the wearable robot according to an embodiment;

FIG. 8 is a view illustrating the inside of a rear supporting portion according to an embodiment;

FIG. 9 is a view illustrating a state in which a contact pad is mounted on the rear supporting portion according to an embodiment;

FIG. 10 is a rear view of the contact pad according to an embodiment;

FIG. 11 is a plan view of the wearable robot according to an embodiment;

FIG. 12 is a view illustrating an upper binder and a contact pad according to an embodiment;

FIG. 13 is a view illustrating a lower binder and a contact pad according to an embodiment;

FIG. 14 is a rear view illustrating an upper rotational shaft and a lower rotational shaft according to an embodiment; and

FIG. 15 is a side view illustrating the upper rotational shaft and the lower rotational shaft according to an embodiment.

### DETAILED DESCRIPTION

Hereinafter, specific embodiments will be described in detail with reference to the accompanying drawings.

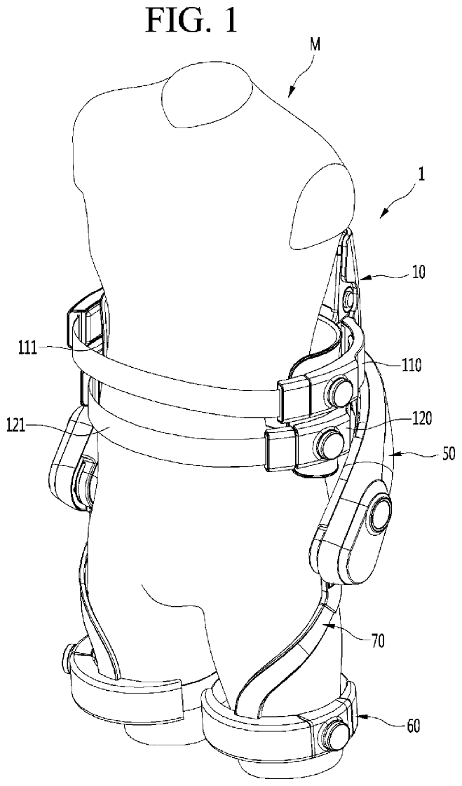

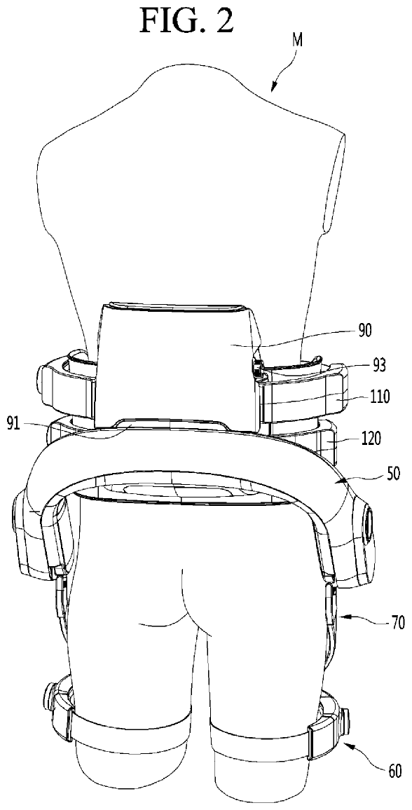

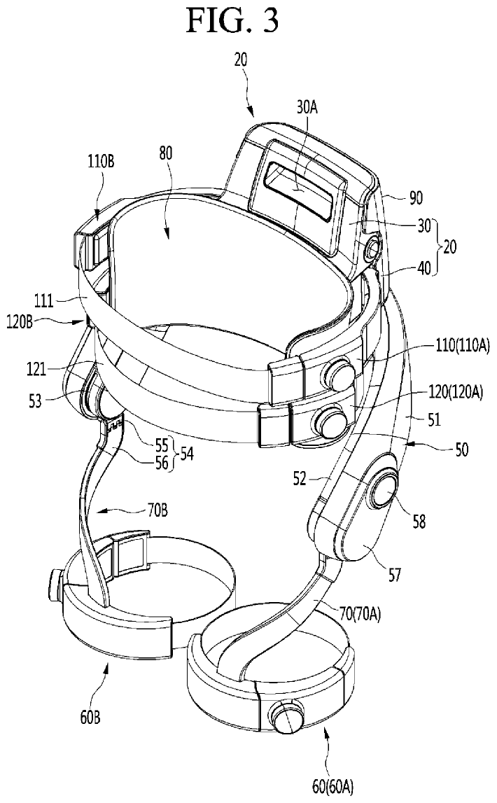

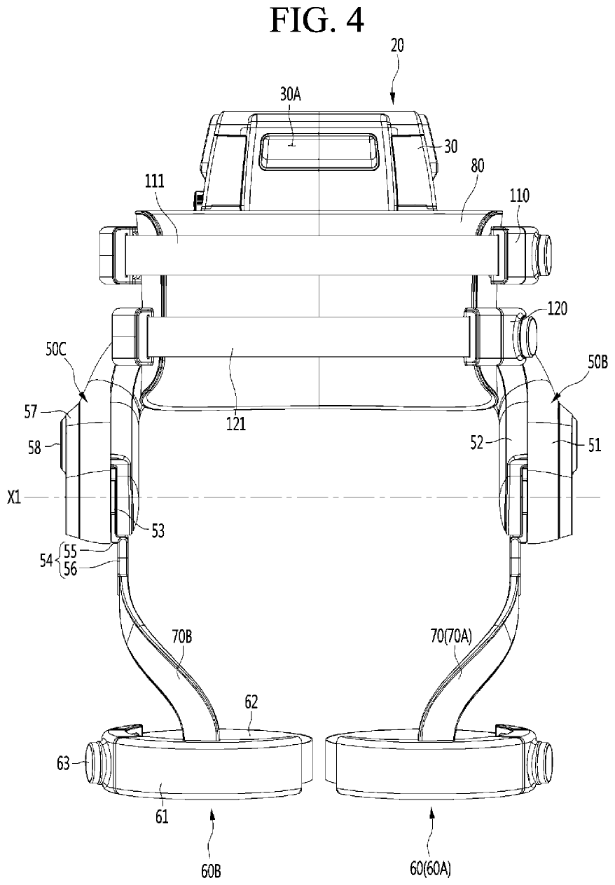

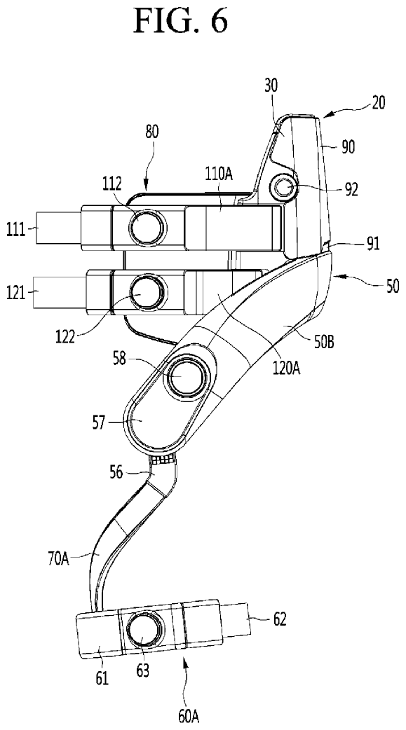

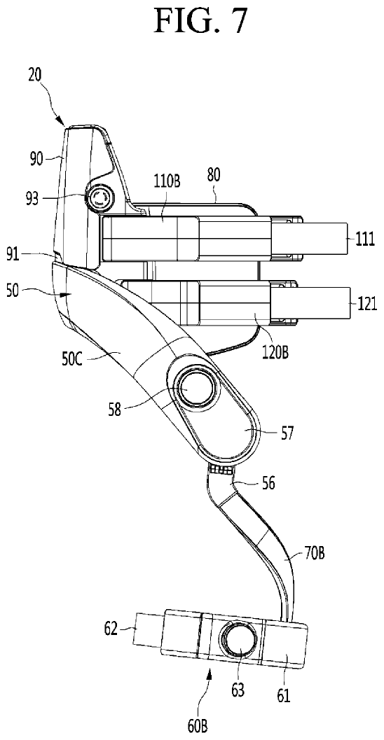

Referring to FIGS. 1 through 8, a wearable assistive device such as a wearable robot 1 (e.g., exoskeleton) according to an embodiment may be worn on a body M of a user. The wearable robot 1 may include a main body 10 which may form an appearance of the wearable robot 1. The main body 10 may include a rear supporting portion or rear support 20 (e.g., a lumbar/back frame) and a hip joint driving unit or main frame 50. The hip joint driving unit 50 may also be referred to as a waist/pelvic support or a hip support, and may include an actuated hip joint.

The rear supporting portion 20 may be provided behind the body M (e.g., at a back or lumbar of the body M). The rear supporting portion 20 may be formed in a substantially box shape, but is not limited thereto.

A light emitting portion or an illuminated section 91 may be provided on a rear surface of the rear supporting portion 20. The light emitting portion 91 may include at least one light source or light-emitting device (e.g, a light-emitting diode or LED) to emit or flicker light. The light emitting portion 91 may be provided between a rear cover 90 and the hip joint driving unit 50.

The light emitting portion 91 may be used in various, unlimited ways. For example, when the user wears the wearable robot 1 and is in a dark place, another person may easily recognize the position of the user by the light emitted from the light emitting portion 91.

Switches 92 and 93 may be provided on at least one side surface of the rear supporting portion 20 at an upper portion of the side surface. The rear supporting portion 20 may have two side surfaces corresponding to two sides of a user, and switch 92 may be provided on a first side surface while switch 93 may be provided on a second side surface. Therefore, the user may easily press or operate the switches 92 and 93.

The types of the switches 92 and 93 are not limited. For example, switch 92 may be a power switch 92 provided on the first side of the rear supporting portion 20 to power on or off the wearable robot 1, and the switch 93 may be an emergency stop switch provided on the second side of the rear supporting portion 20 to power off the wearable robot 1.

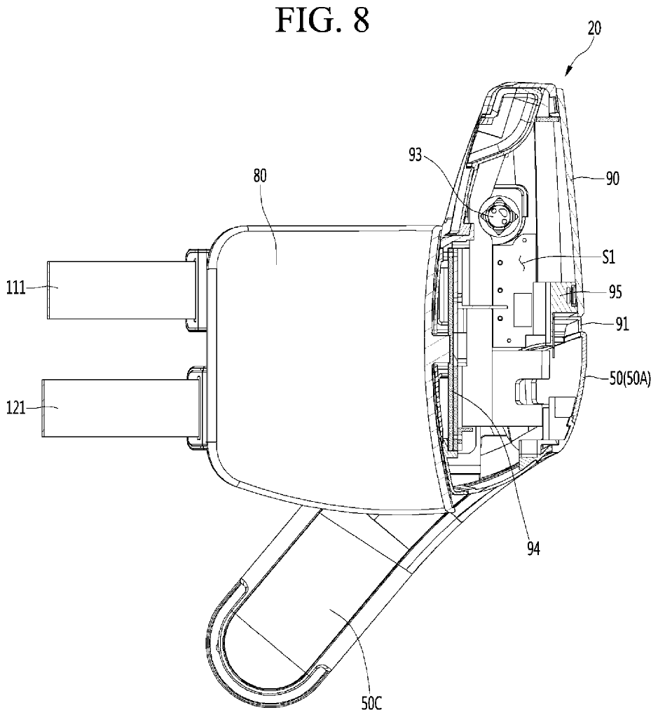

A space S1 (see FIG. 8) may be formed in the rear supporting portion 20. A controller (main controller) 94 that controls an overall operation of the wearable robot 1 may be accommodated in the space S1. The controller 94 may include a printed circuit board (PCB). In addition, a light emitting PCB 95 that controls the light emitting portion 91 may be accommodated in the space S1 inside the rear supporting portion 20. The light emitting PCB 95 may be electrically connected to the controller 94. There may also be an optional subcontroller (not shown) provided in the hip joint driving unit 50. Details of the controller 94 and the subcontroller can be found in U.S. application Ser. No. 16/274,584 (Attorney Docket No. DAE-0073) filed on Feb. 13, 2019 and U.S. application Ser. No. 16/274,613 (Attorney Docket No. DAE-0074) filed on Feb. 13, 2019, the entire contents of which are hereby incorporated by reference.

A rear surface of the rear supporting portion 20 may be opened. The opened rear surface of the rear supporting portion 20 may be at least partially covered by the rear cover 90, and may be at least partially covered by a center portion or center support 50A of the hip joint driving unit 50. The center support 50A may also be referred to as a center plate. The rear cover 90 may be provided above the center portion 50A. The light emitting portion 91 may be provided between the rear cover 90 and the center portion 50A.

The rear supporting portion 20 may include an upper supporting portion or upper support 30 and a lower supporting portion or lower support 40 provided below the upper supporting portion 30. For example, the upper supporting portion 30 may be provided behind the back of the user, and the lower supporting portion 40 may be provided behind the waist or abdomen of the user. The upper supporting portion 30 and the lower supporting portion 40 may be integrally formed. Alternatively, the upper supporting portion 30 and the lower supporting portion 40 may be separately manufactured and then fixed (e.g, bolted or screwed) together.

A handle groove 30A may be formed in the upper supporting portion 30. The handle groove 30A may be recessed rearward from a front surface of the upper supporting portion 30. The user may easily move the wearable robot 1 by putting his or her hand into the handle groove 30A. Alternatively, there may be a handle that extends upward from the upper supporting portion 30 that a user may grasp.

A contact pad 80, which will be described later, may be secured to a front surface of the rear supporting portion 20. As an example, the contact pad 80 may be adhered or bolted to the lower supporting portion 40, or attached to a bottom of the upper supporting portion. The contact pad 80 may be brought into close contact with the back of the user behind the waist.

The hip joint driving unit 50, at the center portion 50A, may be fastened to the rear supporting portion 20 at the lower supporting portion 40. The hip joint driving unit 50 may have a substantially U-shape. A pair of extension portions (first and second extensions) 50B and 50C may extend from the center portion 50A to a portion of the user corresponding to the hip joint.

The pair of extension portions 50B and 50C may include a first extension portion or a first extension 50B extending from a first side of the center portion 50A to a side of a first leg (e.g., along the ilium), and a second extension portion or a second extension 50C extending from a second side of the center portion 50A to a side of a first leg of the user (e.g., along the ilium). The first extension portion 50B and the second extension portion 50C may have heights or thicknesses that decrease toward a front side.

The hip joint driving unit 50 may further include a rotor or rotating plate 53 provided at a lower end of each of the first extension portion 50B and the second extension portion 50C. The rotors 53 provided in the first extension portion 50B and the second extension portion 50C may rotate independently of each other, and may also be referred to as discs.

A motor or actuator (e.g., hydraulic, pneumatic, or electrical) (not illustrated) for rotating the rotor 53 may be provided in each of the first extension portion 50B and the second extension portion 50C. The motor may rotate a rotating shaft (not shown) fixed to the rotor 53.

Each of the center portion 50A, the first extension portion 50B, and the second extension portion 50C may include an outer cover 51 and an inner cover 52, which may be fastened to each other. The outer cover 51 may face an outside or away from the body M, and the inner cover 52 may face the body M. A motor accommodation space (not illustrated) in which the motor is accommodated may be formed between the outer cover 51 and the inner cover 52.

The first extension portion 50B and the second extension portion 50C may further be provided with a side cover 57 to cover the motor accommodation space. The side cover 57 may be coupled to the outer cover 51 of the first extension portion 50B or the second extension portion 50C and thus may be provided outside the lower end of the first extension portion 50B or the second extension portion 50C.

The side cover 57 may be provided with a rotor adjuster 58 (e.g., a rotary dial, knob, or button) to control a rotation of the rotor 53. The user may control an assistive force provided by the rotation of the rotor 53 by operating the rotor adjuster 58. The motor may be electrically connected to the rotor adjuster 58. The configuration of the rotor adjuster 58 is not limited. For example, when the user presses or touches the rotor adjuster 58, a signal may be transmitted to the motor, and the motor may rotate the rotor 53.

The rotor 53 may be provided between the outer cover 51 and the inner cover 52 in a predetermined gap formed between the outer and inner covers 51 and 52 at the lower ends of each of the first and second extension portions 50B and 50C.

The rotor 53 may rotate about a rotational axis X1. The rotational axes X1 of the rotor 53 provided in the first extension portion 50B and the rotor 53 provided in the second extension portion 50C may be provided on a straight line elongated in a horizontal or lateral direction.

The wearable robot 1 may include a leg mounting portion or belt 60 secured to the legs of the user at the thighs, and a leg frame 70 rotated by the rotor 53 and connected to the leg mounting portion 60. The wearable robot 1 may further include a connector or bracket 54 that connects the rotor 53 and the leg frame 70.

The leg mounting portion 60 may have a substantially circular ring shape that wraps around the thighs. A pair of leg mounting portions 60 may be provided to correspond to a pair of legs. In this case, there may be a first leg mounting portion 60A secured to a first thigh and a second leg mounting portion 60B secured to a second thigh.

The leg frame 70 may be fixed to the rotor 53 to rotate or pivot with a rotation of the rotor, which may be driven by the motor. Since the leg frame 70 is secured to the thigh of the user via the leg mounting portion 60, the assistive force may be transmitted to the legs of the user to assist with a walking, bending, or lifting movement. Details of the rotor 53 and the hip joint driving unit 50 may be found in U.S. application Ser. No. 16/282,458 (Attorney Docket No. DAE-0075) filed on Feb. 22, 2019 and Ser. No. 16/353,854 (Attorney Docket No. DAE-0098) filed on Mar. 14, 2019, the entire contents of which are hereby incorporated by reference.

A pair of leg frames 70 may be provided. In this case, the pair of leg frames 7 may include a first leg frame 70A rotated by the rotor 53 provided in the first extension portion 50B and connected to the first leg mounting portion 60A, and a second leg frame 70B rotated by the rotor 53 provided in the second extension portion 50C and connected to the second leg mounting portion 60B.

Each of the leg mounting portions 60 may include a leg binder 61, a leg belt or strap 62, and a leg belt adjuster 63 (e.g., a rotary dial, button, or knob). The leg binder 61 may include a hard material such as a metal material. The leg binder 61 may also be referred to as a support or a frame of the leg belt.

The leg binder 61 may be formed in a substantially circular arc shape so as to cover part of the thighs of the user. The leg belt 62 may connect both ends of the leg binder 61 to each other. The leg belt 62 may include a soft or elastic material. The leg belt 62 may wrap around the thighs of the user together with the leg binder 61.

The leg binder 61 may be provided in front of the leg belt 62 (i.e., on a front of the thigh near the quadriceps). Both ends of the leg binder 61 may be directed substantially rearward. The leg belt 62, meanwhile, may extend or wrap around a rear of the thigh near the hamstrings.

The leg belt adjuster 63 may be provided on the leg binder 61. The user may operate the leg belt adjuster 63 to tighten or loosen the leg belt 62. The configuration of the leg belt adjuster 63 is not limited. For example, the user may tighten or loosen the leg belt 62 by gripping and rotating the leg belt adjuster 63. The user may also tighten or loosen the belt 62 by pushing the leg belt adjuster 63. Therefore, the leg mounting portions 60 may be adjusted to be stably secured to the thighs.

The leg belt adjuster 63 may also be referred to as a wire winder when the leg mounting portion 60 further includes a wire fixed to the leg belt 62. Details of such a leg belt adjuster 63 may be found in U.S. application Ser. No. 16/282,409 (Attorney Docket No. DAE-0084) filed on Feb. 22, 2019, U.S. application Ser. No. 16/352,920 (Attorney Docket No. DAE-0085) filed on Mar. 14, 2019, and U.S. application Ser. No. 16/352,940 (Attorney Docket No. DAE-0086) filed on Mar. 14, 2019, the entire contents of which are incorporated herein by reference.

A lower end of the leg frame 70 may be connected to a front side of the leg mounting portion 60 at an upper surface of the leg binder 61, and an upper end of the leg frame 70 may be connected to the rotor 53 via the connector 54. The upper end of the leg frame 70 may thus be provided at a side of the user (e.g., at a left or a right side), while the lower end of the leg frame 70 may be provided at a front of the user. The leg frame 70 may curve to extend from the rotor 53 to the binder 61.

The leg frame 70 may have an adjustable length via a multi-frame structure. In addition, the leg frame 70 may be detachably coupled to the connector 54, and a connection between the leg frame 70 and the connector 54 may be adjusted to further adjust the length. Details of a curvature of the leg frame 70 and a connection between the leg frame 70 and the connector 54 may be found in U.S. application Ser. No. 16/274,560 (Attorney Docket No. DAE-0072) filed on Feb. 13, 2019, the entire contents of which is incorporated herein by reference.

The connector 54 may include a rotor connecting portion or a rotor bracket 55 connected to the rotor 53, and a leg frame mounting portion or leg frame mount 56 which is hinged to the rotor connecting portion 55 and on which the upper end of the leg frame 70 is mounted. The rotor connecting portion 55 may be positioned under the inner cover 52 at an inner side of the gap formed between the outer cover 51 and the inner cover 52. Therefore, the rotor connecting portion 55 may not interfere with the extension portions 50B and 50C when the rotor 53 rotates.

The leg frame mounting portion 56 may be hinged to the rotor connecting portion 55. A hinge shaft may be provided in the rotor connecting portion 55 formed to extend in a front-rear direction (e.g., along a y-axis perpendicular to the rotational axis X1 of the rotor) so that the leg frame mounting portion 56 can rotate inward and outward (i.e., left and right) about the hinge shaft. Therefore, the leg frame 70 and the leg mounting portion 60 may be rotatable about the hinge shaft, and the leg frame 70 may accommodate various thigh inclinations or sites. In addition, the hip driving unit 50 may also be configured to allow the first and second extensions 50B and 50C to rotate or pivot to the left or right, and, the user may thus freely move the legs to the left and right (e.g., adduction and abduction).

Since the rotor 53 rotates about the rotational axis X1, which extends in the horizontal direction, and the leg frame 70 is connected to the front side of the leg mounting portion 60, the rotational force of the rotor 53 may be easily transmitted to the thighs of the user to assist in rotating the thighs backward and forward. Since the hinge shaft of the connector 54 is formed to extend in the front-rear direction, misapplication of the rotational force of the rotor 53 may be minimized when transmitted to the leg frame 70 because the leg frame 70 will not deviate from the user's legs when the legs move left or right. In other words, the leg frame 70 may remain in close contact with the user's legs during a backward or forward motion despite minor movements to the left or right.

In an alternative embodiment (not shown), the wearable robot 1 may include an upper leg frame corresponding to the thigh, and a lower leg frame corresponding to a calf. The upper leg frame and the lower leg frame may together comprise a leg assembly, which may also include an actuated knee joint or leg drive provided between the upper and lower leg frames. The actuated knee joint may have a motor or actuator (e.g., electric, pneumatic, or hydraulic) to rotate the lower leg frame backward and forward in accordance with a bending of the knee. The wearable robot 1 may further include a foot support provided at a lower end of the lower leg frame to support a foot and ankle. Details of such a leg assembly and foot support may be found in U.S. application Ser. No. 16/274,560 (Attorney Docket DAE-0072) filed on Feb. 13, 2019, and U.S. application Ser. No. 16/274,798 (Attorney Docket No. DAE-0095) filed on Feb. 13, 2019, the entire contents of which are hereby incorporated by reference.

The wearable robot 1 may include the contact pad 80 and binders 110 and 120. The binders 110 and 120 may also be referred to as supports or frames, and may comprise a belt or main structure of a subframe or waist frame.

The contact pad 80 may be secured (e.g., adhered) to a front surface of the lower supporting portion 40. The contact pad 80 may be brought into close contact with the back of the body M of the user and wrap around a rear of the waist.

The contact pad 80 may have a curved plate shape in which ends or sides are bent or curved toward the front side. The contact pad 80 may be ergonomically designed to correspond to a shape or contour of the body M.

The contact pad 80 may be formed to be larger than the binders 110 and 120, and may be formed of a shock-absorbent or elastic material. The binders 110 and 120 may be provided outside the contact pad 80. Therefore, the binders 110 and 120 may press against the contact pad 80 to keep the contact pad 80 contained within the binders 110 and 120. The binders 110 and 120 may further press the contact pad 80 toward the body M of the user so that the contact pad 80 is in close contact with the body M, which may help the wearable robot 1 to be stably worn.

The contact pad 80 may wrap around the waist of the user from a rear toward a front of the user such that the binders 110 and 120 may press the contact pad 80 without directly touching the body M. Such a configuration of the contact pad 80 and the binders 110 and 120 may prevent the user from feeling pain and improve the fit.

The binders 110 and 120 may each be a rigid body. The binders 110 and 120 may have an arc shape having an inner circumference facing the body M of the user. The binders 110 and 120 may be rotatably connected to the rear supporting portion 20 at the lower supporting portion 40.

A plurality of binders 110 and 120 may be provided. For example, the plurality of binders 110 and 120 may include a pair of upper binders 110 and a pair of lower binders 120. The pair of upper binders 110 may be provided above the pair of lower binders 120.

Each pair of binders 110 and 120 may have a binder rotatably coupled to a first (e.g, left) side of the lower supporting portion 40, and a binder rotatably coupled to a second (e.g., right) side of the lower supporting portion 40. For example, the pair of upper binders 110 may include a first upper binder 110A rotatably connected to the first side of the lower supporting portion 40, and a second upper binder 110B rotatably connected to the second side of the lower supporting portion 40. The center portion 50A of the hip joint driving unit 50 may be fixed to an outer or rear surface of the lower supporting portion 40, and may be configured so as not to interfere with the pair of lower binders 120.

The first upper binder 110A and the second upper binder 110B may be spaced apart from each other in the horizontal (i.e., the left-right) direction. The first upper binder 110A may press against a first side of an upper portion of the contact pad 80, and the second upper binder 110B may press against a second side of the upper portion of the contact pad 80. The contact pad 80 may thus be provided between the first upper binder 110A and the second upper binder 110B.

The first upper binder 110A and the second upper binder 110B may be connected to each other by an upper belt or strap 111, which may be adjustable in length. The upper belt 111 may be extend across the front of the body M. The upper belt 111 may be fixed to the first upper binder 110A and detachably coupled to the second upper binder 110B or vice versa. The first and second upper binders 110A and 110B together with the upper belt 111 may comprise an upper belt assembly.

At least one of the first upper binder 110A and the second upper binder 110B may be provided with an upper belt adjuster 112 (e.g., rotary dial, button, or knob). The user may operate the upper belt adjuster 112 to tighten or loosen the upper belt 111.

The configuration of the upper belt adjuster 112 is not limited. For example, the user may tighten or loosen the upper belt 111 by gripping, pressing, and/or rotating the upper belt adjuster 112. When the user adjusts the upper belt adjuster 112 to tighten the upper belt 111, the distance between the first upper binder 110A and the second upper binder 110B may decrease as the first and second upper binders 110A and 110B are pulled closer to each other via a tension in the upper belt 111. The upper portion of the contact pad 80 may also be pressed toward the body M as the upper belt 111 is tightened.

When the user adjusts the upper belt adjuster 112 to loosen the upper belt 111, the distance between the first upper binder 110A and the second upper binder 110B may increase as the first and second upper binders 110A and 110B are restored back to an initial position. The contact pad 80 may not be pressed or may be not be pressed as much as when the upper belt 111 is tightened. In other words, ends or sides of the contact pad 80 may become further apart as the ends or sides are restored back to an initial position.

The pair of lower binders 120 may be provided below the pair of upper binders 110. Part of the binders in the pair of lower binders 120 adjacent to the rear supporting portion 20 may be provided inside the hip joint driving unit 50.

The pair of lower binders 120 may have a configuration similar to a configuration of the pair of upper binders 120. The pair of lower binders 120 may include a first lower binder 120A rotatably connected to the first side of the lower supporting portion 40 and a second lower binder 120B rotatably connected to the second side of the lower supporting portion 40.

The first lower binder 120A and the second lower binder 120B may be spaced apart from each other in the horizontal direction. The first lower binder 120A may press a first (e.g., left) side of a lower portion of the contact pad 80, and the second lower binder 120B may press a second (e.g., right) side of the lower portion of the contact pad 80. The contact pad 80 may thus be provided between the first lower binder 120A and the second lower binder 120B.

The first lower binder 120A and the second lower binder 120B may be connected to each other by a lower belt 121, which may be adjustable in length. The lower belt 121 may extend across the front of the body M. The lower belt 121 may be fixed to the first lower binder 120A and detachably coupled to the second lower binder 120B or vice versa. The first and second lower binders 120A and 120B together with the lower belt 121 may comprise a lower belt assembly. At least one of the first lower binder 120A and the second lower binder 120B may be provided with a lower belt adjuster 122 (e.g., rotary dial, button, or knob). The user may operate the lower belt adjuster 122 to tighten or loosen the lower belt 121.

Like the upper belt adjuster 112, the configuration of the lower belt adjuster 122 is not limited. For example, the user may tighten or loosen the lower belt 121 by gripping, pressing, and/or rotating the lower belt adjuster 122. When the user adjusts the lower belt adjuster 122 to tighten the lower belt 121, the distance between the first lower binder 120A and the second lower binder 120B decreases as the first and second lower binders 120A and 120B become closer to each other. In addition, the lower portion of the contact pad 80 may be pressed toward the body M as the lower belt 121 is tightened.

When the user adjusts the lower belt adjuster 122 to loosen the lower belt 121, the distance between the first lower binder 120A and the second lower binder 120B increases as the first and second lower binders 120A and 120B are restored to an initial position. The contact pad 80 may not be pressed or may not be pressed as much when the lower belt 121 is loosened. In other words, ends or sides of the contact pad 80 may become further apart as the ends or sides are restored back to an initial position.

The upper and lower belt adjusters 112 and 122 may also be or include wire winders when the upper and lower binders 110 and 120 further include wires fixed to the upper and lower belts 111 and 121, respectively. Details of the upper and lower belt assemblies may be found in U.S. application Ser. No. 16/274,662 (Attorney Docket No. DAE-0076) filed on Feb. 13, 2019, U.S. application Ser. No. 16/274,697 (Attorney Docket No. DAE-0077) filed on Feb. 13, 2019, and U.S. application Ser. No. 16/352,940 (Attorney Docket No. DAE-0086) filed on Mar. 14, 2019, the entire contents of which are incorporated herein by reference.

The upper belt 111 and the lower belt 121 may include a soft or elastic material. The wearable robot 1 may be fixed to the abdomen and waist (i.e., the core) of the body M by the upper binder 110 and the lower binder 120, respectively. The upper and lower binders 110 and 120 may prevent the wearable robot 1 from sliding down when the wearer moves while wearing the wearable robot 1. Alternatively, there may be only one of the upper and lower binder 110 and 120, and thus only one of the upper and lower belt 111 and 121 may secure the wearable robot 1 to the body M.

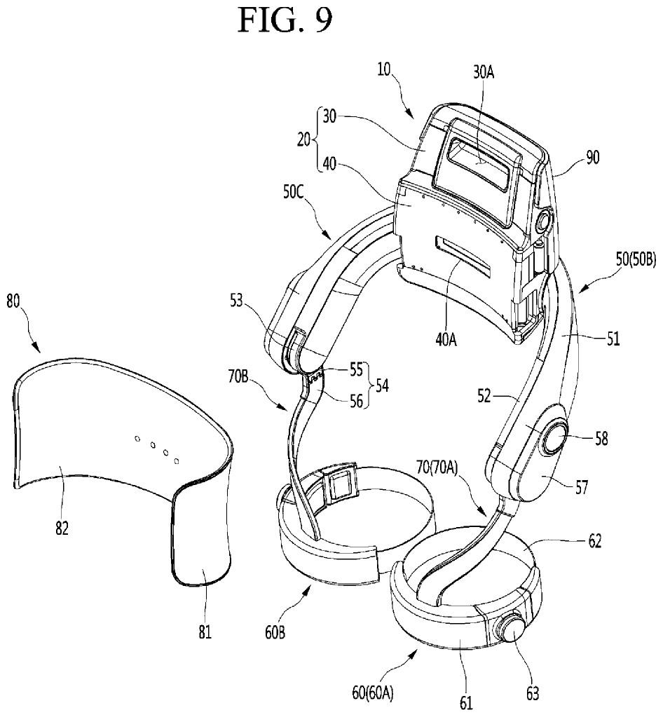

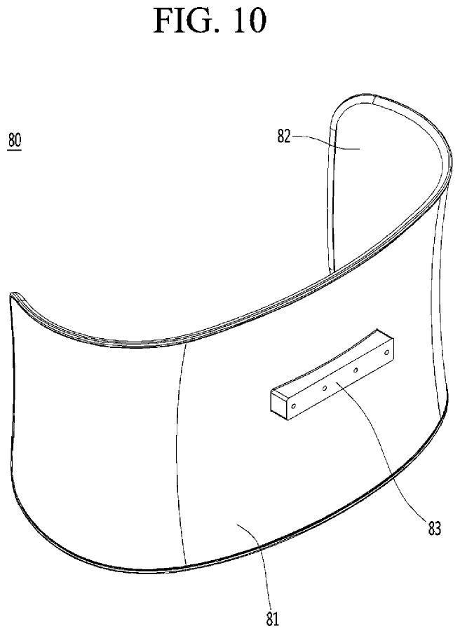

Referring to FIGS. 9 and 10, the contact pad 80 may include a support plate 81 and a cushion 82 provided on a front (i.e., inner) surface of the support plate 81. The cushion 82 may be, for example, adhered or bolted to the front surface of the support plate 81. The support plate 81 may include a hard material. The support plate 81 may be a frame that determines and maintains the overall shape of the contact pad 80. The support plate 81 may pliable enough so that a tightening of the upper or lower belt 111 or 121 may slightly bend the support plate 81.

The inner surface of the support plate 81 may face the body M, and the contact pad 80, when viewed from above, may have a substantially U-shape so that sides of the contact pad 80 extend along sides of the body M. Sides of the contact pad 80 may have a convex shape such that middle portions of the sides of the contact pad 80, which may correspond to a position of a natural waist of the body M, are closer together than top or bottom portions of the sides of the contact pad 80. The contact pad 80 may thus have a shape that conforms to a shape of the waist of the body M to be in close contact the body M.

The support plate 81 may be fastened to the rear supporting portion 20 at the lower supporting portion 40 or, alternatively, at a lower portion of the upper supporting portion 30. A protrusion or guide 83 protruding toward the rear supporting portion 20 may be formed on a back (i.e., outer) surface of the support plate 81. An insertion groove 40A into which the protrusion 83 is inserted may be formed by being recessed rearward in the front surface of the lower supporting portion 40.

An installation position of the contact pad 80 may be guided by an insertion of the protrusion 83 into the insertion groove 40A. The protrusion 83 may further include fastening holes, which may penetrate the inner surface of the support plate 81. At least one fastening member (not illustrated) such as a screw or bolt may be inserted through the fastening holes and fastened to the insertion groove 40A to fix the contact pad 80 to the rear supporting portion 20.

The cushion 82 may be or include a soft and/or elastic material. The cushion 82 may be provided on the front surface of the support plate 81 and surround an edge of the support plate 81. The cushion 82 may be in close contact with the body M of the user. Since the cushion 82 includes a soft and/or elastic material, a contact area where the cushion 82 contacts the body M may be maximized. A friction force between the contact pad 80 and the body M may thus increase, and the wearable robot 1 may be more stably worn on the body M.

The wearable robot 1 may be fixed to the body M only by the contact pad 80. In other words, the contact pad 80 may be configured such that the friction force between the contact pad 80 and the body M when the upper and/or lower belts 110 and/or 120 are fastened is sufficient to keep the wearable robot 1 secured to the body M, even without the leg binders 61 or the leg mounting portion 60. Thus, if the leg belt 62 accidentally becomes loosened or unfastened, the wearable robot 1 may continue to be secured to the body M.

An adjustment of the upper, lower, and leg binders 110, 120, and 61 may be simple and convenient enough that the adjustment may be facilitated by the user alone. In addition, the contact pad 80 and the cushion 82 may provide more comfort and stability than a conventional securing method of a wearable robot.

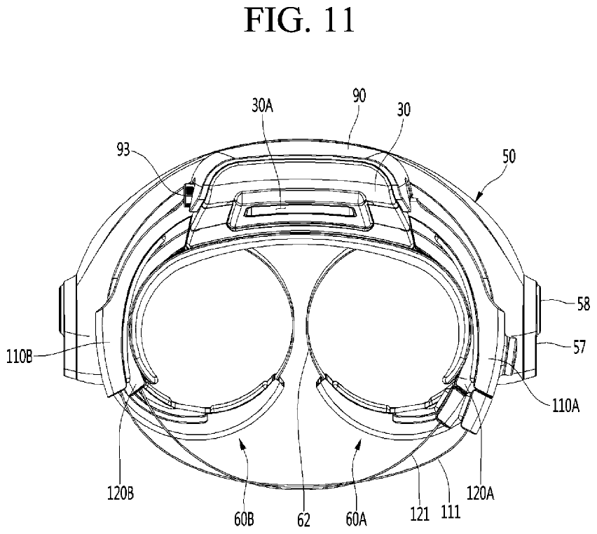

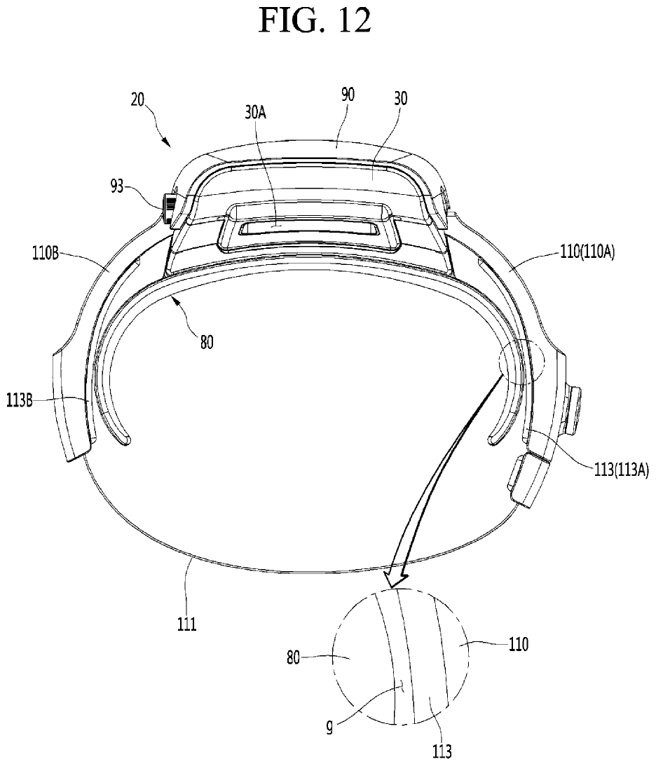

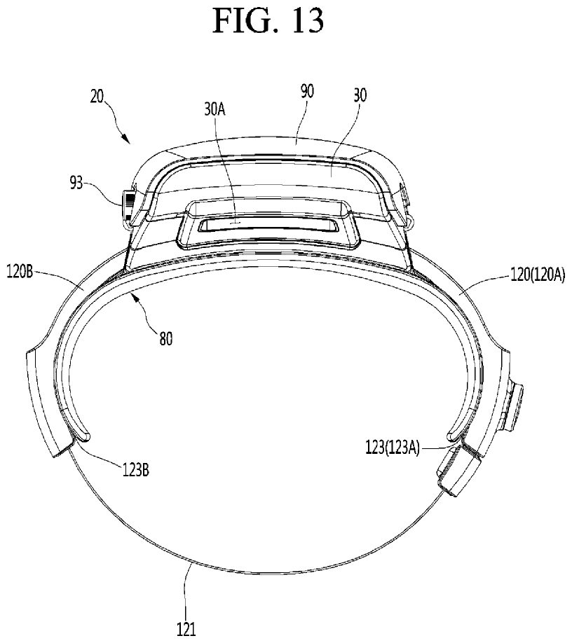

Referring to FIGS. 11 through 13, at least part of the space inside the leg mounting portion 60 may vertically overlap the space inside the binders 110 and 120 and the belts 111 and 121. The leg may be inserted into the leg mounting portion 60 from an upper side and extended to a lower side of the wearable robot 1, similar to a process where a person puts on pants. Therefore, the user may easily attach and detach the wearable robot 1 even when the user is standing.

Inner surfaces of the binders 110 and 120 may face the body M of the user and the contact pad 80. Pressing portions or impact cushions 113 and 123 may be provided on the inner surfaces of the binders 110 and 120. When the upper and lower belts 111 and 121 are tightened, the pressing portions 113 and 123 may come into contact with the contact pad 80 and the upper and lower binders 110 and 120 may press against the contact pad 80.

The pressing portions 113 and 123 may include an elastic material such as rubber or silicone. When the binders 110 and 120 press against the contact pad 80, the pressing portions 113 and 123 may be pressed and elastically deformed between the binders 110 and 120 and the contact pad 80. Therefore, the pressing portions 113 and 123 may absorb an impact between the binders 110 and 120 and the contact pad 80.

As an example, an upper pressing portion 113 may be provided on the inner surface of the upper binder 110, and may include first and second upper pressing portions 113A and 113B. The first upper pressing portion 113A may be provided on the inner surface of the first upper binder 110A, and the second upper pressing portion 113B may be provided on the inner surface of the second upper binder 110B.

In addition, the lower pressing portion 123 may be provided on the inner surface of the lower binder 120, and may include first and second lower pressing portions 123A and 123B. The first lower pressing portion 123A may be provided on the inner surface of the first lower binder 120A, and the second lower pressing portion 123B may be provided on the inner surface of the second lower binder 120B.

The pressing portions 113 and 123 may be separated from or come into contact with the contact pad 80 according to a rotation state of each of the binders 110 and 120, which may be hinged to the lower supporting portion 40. As an example, a connection of the upper pressing portion 113 to the lower supporting portion 40 may be configured such that a predetermined gap g may be formed between the contact pad 80 and the upper pressing portion 113 when the upper belt 111 is not tightened or fastened. A similar gap may be formed between the contact pad 80 and the lower pressing portion 112 when the lower belt 121 is not tightened or fastened. When the user tightens only the lower belt 121, the lower pressing portion 123 may come into contact with the contact pad 80 while the upper pressing portion 113 may remain separated from the contact pad 80.

The inner surface of the upper binder 110 and the inner surface of the lower binder 120 may have different curvatures. The inner surface of the upper binder 110 may have a first curvature, and the inner surface of the lower binder 120 may have a second curvature larger or higher (i.e., rounder or tighter) than the first curvature. The lower binder 120 may therefore be more curved than the second upper binder 110 to accommodate a natural waist of the body M. A radius of curvature of the lower binder 120 may be smaller than a radius of curvature of the upper binder 110.

An overall circumferential or arc length of the lower binder 120 may be smaller than a circumferential or arc length of the upper binder 110 because the body M is generally thicker in the upper abdomen than in the waist. Since the inner surfaces of the upper binder 110 and the lower binder 120 have different curvatures, the contact pad 80 may be pressed toward the body M according to these body characteristics such that the cushion 81 is in close contact with the body M. Therefore, comfort to the user may be further improved.

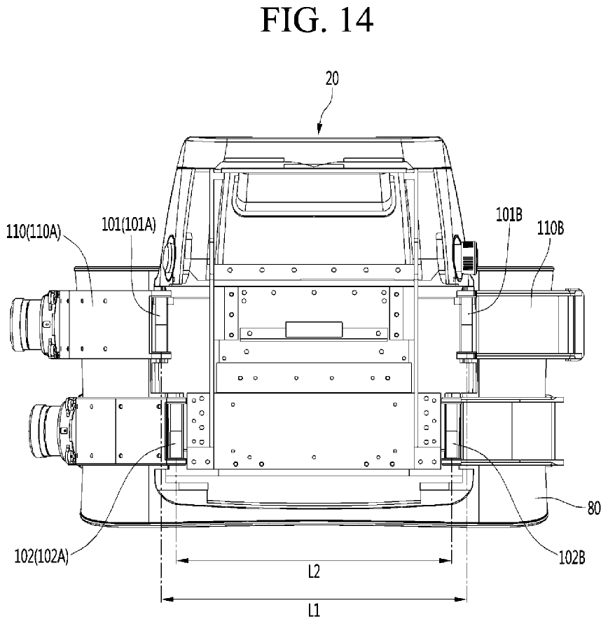

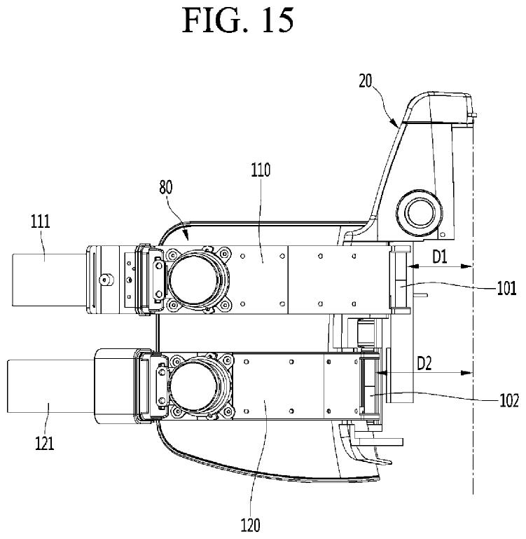

Referring to FIGS. 14 and 15, the binders 110 and 120 may be rotatably connected to the rear supporting portion 20 at the lower supporting portion 40. The lower supporting portion 40 may be provided with rotational shafts 101 and 102 to which the binders 110 and 120 are connected. The rotational shafts 101 and 102 may be, for example, hinge shafts around which hinge brackets of the binders 110 and 120 rotate or pivot around, respectively. Further details of how the binders 110 and 120 are coupled to and pivot around the rear supporting portion 20 are found in U.S. application Ser. No. 16/274,662 (Attorney Docket No. DAE-0076) and Ser. No. 16/274,697 (Attorney Docket No. DAE-0077), both filed on Feb. 13, 2019, the entire contents of which are incorporated herein by reference.

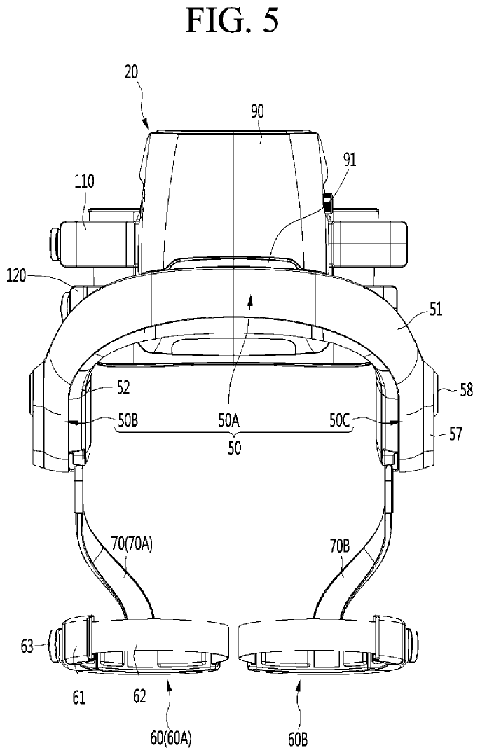

The rotational shafts 101 and 102 may be covered by at least one of the center portion 50A of the hip joint driving unit 50 (see FIG. 5) or the rear cover 90. The rotational shafts 101 and 102 may be elongated in the vertical direction, and the binders 110 and 120 may be rotated in the front-rear direction (i.e., around a vertical z-axis).

The upper binder 110 may be connected to a pair of upper rotational shafts 101. In this case, the pair of upper rotational shafts 101 may include a first upper rotational shaft 101A to which the first upper binder 110A is connected, and a second upper rotational shaft 101B to which the second upper binder 110B is connected.

The pair of lower binders 120 may be connected to the pair of lower rotational shafts 102. In this case, the pair of lower rotational shafts 102 may include a first lower rotational shaft 102A to which the first lower binder 120A is connected, and a second lower rotational shaft 102B to which the second lower binder 120B is connected.

The first upper rotational shaft 101A and the second lower rotational shaft 102A may be provided on the first side of the lower supporting portion 40, and the second upper rotational shaft 101B and the second lower rotational shaft 102B may be provided on the second side of the lower supporting portion 40.

The first upper rotational shaft 101A and the second upper rotational shaft 101B may be spaced apart from each other by a first length L1 in the horizontal direction. In addition, the first lower rotational shaft 102A and the second lower rotational shaft 102B may be spaced apart from each other by a second length L2 in the horizontal direction.

The second length L2 may be shorter than the first length L1. A midpoint of the first length L1 and a midpoint of the second length L2 may be provided on a vertical axis or line M1 longitudinally crossing the rear supporting portion 20 (i.e., in a z-axis direction). When the wearable robot 1 is viewed from a rear side, the midpoint of the pair of upper rotational shafts 101 and the midpoint of the pair of lower rotational shafts 102 may be provided on a straight line in the vertical direction.

Referring to FIG. 15, a virtual vertical or longitudinal plane A1 may extend downward (i.e., in the z-axis direction) from an end of the outermost portion of the upper supporting portion 30 or the rear supporting portion 20. The vertical plane A1 may be parallel to an outer face of the rear supporting portion 20. The upper and lower rotational shafts 101 and 102 may be spaced apart from the vertical plane A1 in a horizontal or lateral direction (i.e., in the y-axis direction or the forward-backward direction).

A first distance D1 between the vertical plane A1 and the upper rotational shaft 101 may be shorter than a second distance D2 between the vertical plane A1 and the lower rotational shaft 102. In other words, the upper binders 110 may extend further backward than the lower binders 120 because the body M is generally thicker in the abdomen than in the waist, not only in the left-right (x-axis) direction but also in the forward-backward (y-axis) direction. The upper binder 110 and the lower binder 120 may therefore press against the contact pad 80 according to these body characteristics. Therefore, comfort of the user may be further improved.

The first and second lengths L1 and L2 and the first and second distances D1 and D2 may alternatively be referred to as first and second distances L1 and L2, and third and fourth distances D1 and D2. First and second lengths L1 and L2 may extend in a first horizontal or lateral direction, while first and second distances D1 and D2 may extend in a second horizontal or lateral direction.

According to embodiments disclosed herein, a horizontal distance between a pair of lower rotational shafts around which lower binders may rotate may be shorter than a horizontal distance between a pair of upper rotational shafts around which upper binders may rotate. Therefore, the wearable robot may be worn according to body characteristics, such as waist and abdomen thickness, in which the abdomen is generally thicker than the waist. Therefore, the comfort of the user may be improved when the user wears the wearable robot. In addition, since the wearable robot is secured by the upper binder and the lower binder according to typical body characteristics (i.e., typical dimensions of the core or torso), the wearable robot may be stably worn by and secured to the user.

The wearable robot may be vertically fixed to the body of the user by the upper binder and the lower binder. Therefore, it is possible to prevent the wearable robot from sliding down even when the user moves while wearing the wearable robot.

Embodiments disclosed herein may provide a wearable robot which is stably worn and held by a user. Embodiments may also provide a wearable robot allowing a wearer to feel comfortable.

In an embodiment, a wearable robot may include a rear supporting portion or a rear support provided behind a body of a user and a hip joint driving unit or a main frame, which may include an actuated hip joint. The hip joint driving unit may include a center portion or support fastened to the rear supporting portion and a pair of extension portions or extensions extending from the center portion to a hip joint side of the user. A pair of upper rotational shafts may be provided on the rear supporting portion and spaced apart from each other by a first distance in a horizontal direction, and a pair of upper binders may be connected to the upper rotational shafts. A pair of lower rotational shafts may be provided on the rear supporting portion and spaced apart from each other by a second distance shorter than the first distance in a horizontal direction, and a pair of lower binders may be connected to the lower rotational shafts and provided below the upper binders.

A midpoint of the pair of upper rotational shafts and a midpoint of the pair of lower rotational shafts may be provided on a virtual vertical plane crossing the rear supporting portion. A front-rear distance between a rear end of the rear supporting portion and the upper rotational shaft may be shorter than a front-rear distance between the rear end of the rear supporting portion and the lower rotational shaft.

An inner surface of the upper binder may have a first curvature in a direction wrapping the body of the user, and an inner surface of the lower binder may have a second curvature larger than the first curvature. The wearable robot may further include an upper belt which connects the pair of upper binders and is adjustable in length, and a lower belt which connects the pair of lower binders and is adjustable in length.

The above description is merely illustrative of the technical idea of the present disclosure, and various modifications and changes may be made thereto by those skilled in the art without departing from the essential characteristics of the present disclosure. Therefore, the embodiments of the present disclosure are not intended to limit the technical spirit of the present disclosure but to illustrate the technical idea of the present disclosure, and the technical spirit of the present disclosure is not limited by these embodiments. The scope of protection of the present disclosure should be interpreted by the appending claims, and all technical ideas within the scope of equivalents should be construed as falling within the scope of the present disclosure.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A wearable robot comprising:
a rear support provided behind a body;
a hip support comprising a center support fixed to the rear support and a pair of extensions extending from the center support around a hip of the body;
a pair of upper rotational shafts provided on the rear support and spaced apart from each other by a first length in a first horizontal direction;
a pair of upper binders rotatably coupled to the pair of upper rotational shafts, respectively;
a pair of lower rotational shafts provided on the rear support and spaced apart from each other by a second length shorter than the first length in the first horizontal direction; and
a pair of lower binders rotatably coupled to the pair of lower rotational shafts, respectively, and provided below the upper binders.

2. The wearable robot according to claim 1, wherein a midpoint of the first length and a midpoint of the second length are provided along a same vertical axis.

3. The wearable robot according to claim 1, wherein a first distance in a second horizontal direction between a vertical plane extending from an outermost portion of the rear support and one upper rotational shaft in the pair of upper rotational shafts is shorter than a second distance in the second horizontal direction between the vertical plane and one lower rotational shaft of the pair of lower rotational shafts.

4. The wearable robot according to claim 1, wherein inner surfaces of the upper binders have a first curvature to wrap around sides of the body, respectively, and
inner surfaces of the lower binders have a second curvature larger than the first curvature such that a radius of curvature of the lower binders is smaller than a radius of curvature of the upper binder.

5. The wearable robot according to claim 4, wherein the upper binders wrap around sides of the body at the abdomen, and the lower binders wrap around sides of the body at the waist.

6. The wearable robot according to claim 1, further comprising:
an upper belt which connects the pair of upper binders and is adjustable in length; and
a lower belt which connects the pair of lower binders and is adjustable in length.

7. The wearable robot according to claim 1, wherein the extensions include an actuator that provides an assistive force.

8. A wearable robot comprising:
a rear support;
a hip support comprising a center support fixed to the rear support and a pair of extensions extending from the center support;
a pair of leg frames extending from the pair of extensions, respectively;
a pair of leg binders coupled to the pair of leg frames, respectively, the leg binders configured to wrap around a front of a thigh; and
a pair of leg belts coupled to the leg binders, respectively, the leg belts configured to extend across a rear of the thigh.

9. The wearable robot of claim 8, wherein lengths of the leg belts are adjustable.

10. The wearable robot of claim 8, wherein the leg frames extend from ends of the extensions to the leg binders such that the leg frames are curved from a side of the hip to the front of the thigh.

11. The wearable robot of claim 8, further including a connector provided between the leg frame and the extension.

12. The wearable robot of claim 11, wherein the connector includes a shaft around which the leg frame freely rotates toward and away the thigh.

13. The wearable robot of claim 11, further including a rotating plate provided in the extension that is rotated by a motor provided in the extension, wherein the connector is fixed to the rotating plate such that the leg frame rotates frontward and rearward with a rotation of the connector and the rotating plate.

14. The wearable robot of claim 8, further including at least one motor that provides an assistive force to move the leg, wherein a magnitude of the assistive force is adjustable via a rotary dial provided on the wearable robot.

15. A wearable robot comprising:
a rear support;
a hip support fixed to the rear support and including at least one extension;
an actuator provided in the hip support;
a controller provided in at least one of the rear support or the hip support to control the actuator;
a first upper binder and a first lower binder provided at a first side of the rear support,
a second upper binder and a second lower binder provided at a second side of the rear support
an upper belt extending between the first and second upper binders to form an upper belt assembly having a first circumference, and
a lower belt extending between the first and second lower binders to form a lower belt assembly having a second circumference, wherein the second circumference is smaller than the first circumference.

16. The wearable robot of claim 15, further including first and second upper rotational shafts around which the first and second upper binders rotate, respectively.

17. The wearable robot of claim 15, further including first and second lower rotational shafts around which the first and second lower binders rotate, respectively.

18. The wearable robot of claim 15, wherein a length of the first upper binder is greater than a length of the first lower binder.

19. The wearable robot of claim 15, wherein a distance between the first and second upper binders is greater than a distance between the first and second lower binders.

20. The wearable robot of claim 15, wherein an end of the extension is provided at a position corresponding to a position of a hip joint, and the actuator is provided in an end of the extension to rotate a disc.
